(19) United States
(12) Patent Application Publication
(10) Pub. No.: US 2026/0110893 A1
(43) Pub. Date: Apr. 23, 2026

(54) Method For Producing A Long-Range Optical Apparatus

(71) Applicant: Swarovski-Optik AG & Co KG., Absam (AT)

(72) Inventors: Peter Öttl, Mils (AT); Andreas Zimmerman, Fulpmes (AT); Christoph Frech, Thaur (AT); Florian Schletterer, Breitenbach Am Inn (AT); Dale Forbes, Hall in Tirol (AT); Daniel Nindl, Innsbruck (AT)

(73) Assignee: Swarovski-Optik AG & Co KG., Absam (AT)

(21) Appl. No.: 18/918,345

(22) Filed: Oct. 17, 2024

Related U.S. Application Data
(63) Continuation of application No. 16/159,207, filed on Oct. 12, 2018, now abandoned.

(30) Foreign Application Priority Data
Oct. 12, 2017 (AT) A50869/2017

(51) Int. Cl. G02B 23/18; B29C 64/00; B33Y 80/00; G02B 7/02; G02B 23/14

(52) U.S. Cl. CPC G02B 23/18; B29C 64/00; B33Y 80/00; G02B 23/14; G02B 7/022

(57) ABSTRACT

The invention relates to a long range optical apparatus, an operating part of a long range optical apparatus, an accessory part of a long range optical apparatus and a method for producing a long range optical device, in particular, a binocular or monocular telescope, spotting scope, rifle scope, night vision device or range finder, and/or at least one accessory part and/or at least one operating part and/or at least one housing part of the long range optical apparatus, wherein the long range optical apparatus comprises at least one housing, characterized in that the long range optical apparatus and/or the at least one accessory part and/or the at least one operating part and/or the at least one housing part is/are produced at least partially with at least one 3D printing method.

### CROSS-REFERENCE FOR APPLICATIONS

The present application is a continuation of U.S. patent application Ser. No. 16/159,207, filed on Oct. 12, 2018, which claims priority to AT Patent Application No. A50869/2017, filed on Oct. 12, 2017, the disclosures which is hereby incorporated herein by reference.

### BACKGROUND OF THE INVENTION

The invention relates to a method for producing a long-range optical apparatus, in particular, a binocular or monocular telescope, a spotting scope, a rifle scope, a night vision device or a range finder, and/or at least one accessory part and/or at least one operating part and/or at least one housing part of the long-range optical apparatus, wherein the long-range optical apparatus comprises at least one housing.

Furthermore, the invention relates to a long-range optical apparatus, in particular, a binocular or monocular telescope, a spotting scope, a rifle scope, a night vision device or a range finder, with at least one housing.

In addition, the invention relates to an accessory part for a long-range optical apparatus, in particular, a carrying strap, a bag, a protective case, an objective lens cover or an eyepiece cover, a holding frame, in particular, an anatomically shaped holding frame for attaching the long-range optical apparatus to the head of a user.

In addition, the invention also has an operating part, in particular, a focus adjustment element, a magnification adjustment element, a diopter compensation adjustment element, a ballistic turret and/or a switch, as the subject matter.

In addition, the invention relates to a 3D printing apparatus with at least one printer controller and at least one electronic memory, wherein the printer controller is configured to control at least one print head for producing an object by means of data, stored in the electronic memory.

### BRIEF SUMMARY OF THE INVENTION

The drawbacks with the conventional manufacturing methods for producing long range optical apparatuses, parts thereof or their accessories are the high amount of effort involved in the production process and the associated costs. It is also not possible with the conventional manufacturing methods to make user-specific, customized productions of long-range optical apparatuses or accessory parts.

The object of the present invention is to overcome the drawbacks of the prior art and to reduce the amount of effort involved in the production process of long-range optical apparatuses and the accessories thereof and to enable customization in accordance with specific customer requirements.

This object is achieved, according to the invention by the fact that the long range optical apparatus and/or the at least one accessory part and/or the at least one operating part and/or the at least one housing part is/are produced at least partially with a 3D printing method.

The aforementioned object of the invention can also be achieved with an accessory part for a long-range optical apparatus in that the accessory part is produced at least partially with a 3D printing method.

The object, on which the invention is based, can also be achieved with an operating part long range optical apparatus, wherein said operating part is produced, according to the invention, at least partially with a 3D printing method.

In addition, the aforementioned object can be achieved, according to the invention, with a 3D printing apparatus in that at least one 3D model of at least one basic element of a long-range optical apparatus and/or at least one accessory part and/or at least one operating part and/or at least one housing part and/or at least one other part of the long-range optical apparatus that is to be printed is stored in electronic form in the electronic memory.

The aforementioned object of the invention can also be achieved, according to the present invention, with a telescope in that said telescope comprises at least one part that is produced by at least one 3D printing method.

### BRIEF DESCRIPTION OF THE DRAWINGS

In order to better understand the invention, this invention is explained below in greater detail with reference to the accompanying figures.

The drawings, shown in a highly simplified schematic form, show in:

FIG. 1 a first variant of a long-range optical apparatus, according to the invention;

FIG. 2 a printing apparatus, according to the invention;

FIG. 3 a detail of the long-range optical apparatus from FIG. 1;

FIG. 4 a second variant of a long-range optical apparatus, according to the invention;

FIG. 5 a detail of a housing of a long-range optical apparatus with an add-on part;

FIG. 6 a detail of the housing from FIG. 5 with the add-on part removed;

FIG. 7 a detail of a housing of a long-range optical apparatus with an objective lens cover;

FIG. 8 a detail of a connecting piece for attaching the objective lens cover to the housing from FIG. 7;

FIG. 9 a detail of an interface of the housing from FIG. 7 for connecting the connecting piece of the objective lens cover to the housing;

FIG. 10 a third variant of a long-range optical apparatus, according to the invention;

FIG. 11 an operating element of the long-range optical apparatus from FIG. 10 in greater detail.

### DETAILED DESCRIPTION

To begin with, it should be noted that identical parts are provided with the same reference numerals or the same component names in the various descriptions of the embodiments, wherein the disclosures, included in the entire specification, may be transferred mutatis mutandis to those identical parts bearing the same reference numerals or those components with the same names. Even the information regarding the orientation that is chosen in the description, such as, for example, top, bottom, laterally, etc. is based on the figure that is shown and described in the specific case; and this information regarding the orientation is to be transferred mutatis mutandis to the new orientation when the orientation is changed.

At this point it should be noted that the term “3D printing” in this document is defined very loosely as an additive manufacturing method for building a workpiece layer by layer. The term “long range optical apparatus” in this document is defined as an optical apparatus for observing an object that is at least two meters away from the observer.

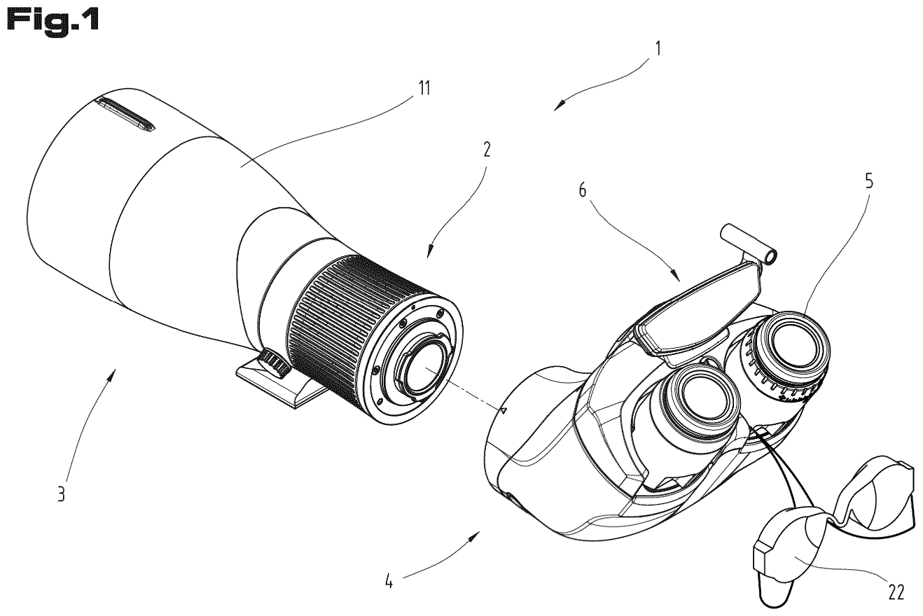

FIG. 1 shows a long-range optical apparatus 1 that is produced according to the method of the present invention. In this case the long-range optical apparatus 1 and/or at least one accessory part and/or at least one operating part 2 and/or a housing part 3, 4 is/are produced in part or in whole with a 3D printing method in accordance with the invention. However, the method of the invention can be used to produce a contact part that is anatomically adapted to a user. The contact part may be, for example, a holding part, in particular, a grip or a grip shell of the long-range optical apparatus 1 or, as shown in FIGS. 1 and 3, an eye cap 5 and a support part 6, against which the forehead of a user rests. In order to produce the contact part, an actual anatomical shape of a user's body part, which comes into contact with the long-range optical apparatus 1, can be determined. Then a contact section of the contact part that rests against the body part when the long-range optical apparatus 1 is used can be printed according to the actual anatomical shape. The contact element may also be, for example, an anatomically shaped bracket for attaching to the head of a user. Owing to the invention the comfort and the ease, with which the long-range optical apparatus can be operated, can be significantly enhanced. A further advantage of this embodiment is the fact that there is the possibility with long range optical devices of providing a contact part, which is both customized and optimally adapted to the user; and hence it is possible to build a customized long range optical device. There is no need to make compromises with respect to an adaptation to the actual physical conditions; similarly it is possible to dispense with the requirement of having to manufacture a plurality of different (housing) variants of the long-range optical device, in order to be able to meet, nevertheless, only a major portion of the specific conditions of the user. A significant increase in user satisfaction can be achieved with the invention. Furthermore, the application efficiency of the long-range optical device also increases, since the device is adapted to the respective user; and operating errors caused by mishandling are reduced or eliminated. The accessory part may be, for example, a bag, a protective case, a carrying strap, an objective lens cover or, as shown in FIGS. 1 and 3, an eyepiece cover 22.

In the variant that is shown in FIG. 1 merely for illustrative purposes, the apparatus 1 of the present invention is designed as a telescope.

The 3D printing method may be, for example, a free space method, in particular, a free space method with a volume variable material; a powder bed method; a laser beam melting method; an electronic beam melting method; a stereolithography method; a digital light processing method; a poly-jet modeling method; a fused deposition modeling method; a multi-jet modeling method; a binder jetting method; a laser deposition welding method or a cold gas spraying method or a combination of two or more of the aforementioned methods. Thus, for example, a metal part of the telescope can be produced by a laser deposition welding method, whereas optical components, such as the lenses, can be made, for example, from quartz powder or glass powder by means of multi-jet modeling.

For example, it can be provided that a volume change is triggered under thermal influence and vanishes again when the thermal influence ceases. Optionally this can also be associated with a change in the material properties, for example, in that the material becomes somewhat elastic when the volume changes. Since the individual anatomical conditions are also a function of the day, in this case slightly swollen fingers can be mentioned as an example, this further development makes it possible to produce a contact piece, which has been optimally adapted to the user and which adapts by means of the volume variable material to exactly the respective anatomical conditions that prevail on a given day when the long-range optical device is used.

A free space method is, for example, a 3D printing method, in which a material that can be melted is applied layer by layer by means of a coordinate head. After hardening, the result will be a solid piece. In a powder bed method a powder that can be melted is applied in thin layers and molten by a point-shaped energy source, typically a laser, in defined structures, as a result of which it connects to a structure that had been previously applied. The advantage of this method is that even materials with a high melting temperature can be used, in particular, metals. A powder bed method has the additional advantage that even complex undercuts can be generated, as required, for example, for a hand grip piece, in order to ensure the best possible adaptation to the anatomical conditions, for example, the fingers.

In the context of the production at least one model of a basic element of the long-range optical apparatus 1, for example, a housing or a housing part and/or the accessory part and/or the operating part 2, the contact part and/or at least one other part of the long-range optical apparatus 1 that is to be printed can be stored in electronic form. The model may be created and stored, for example, as a CAD model. The stored CAD models can be converted into the surface tessellation language STL in order to control the printer. Storing as a CAD model makes it possible to further process, modify and adapt the model in an easy way. In addition, it is also possible to transfer the CAD model over the Internet to a geographically distant 3D printer or a suitable fabrication shop and to have the finished product delivered. It is conceivable that the data can be transmitted directly to an end user (customer), who can also print the product, component, accessory part himself and easily at home.

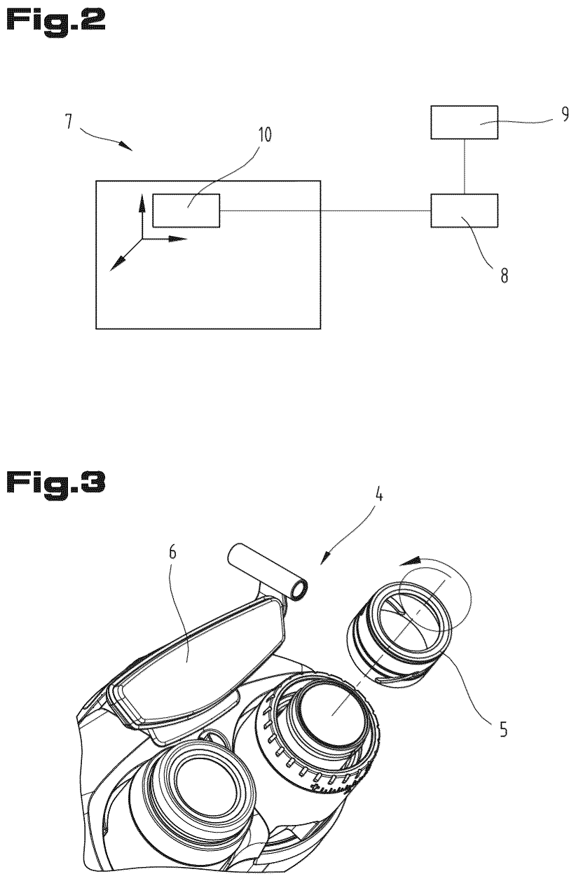

In order to produce a part of the long-range optical apparatus 1, for example, of one or all of the housing parts 3, 4 or the operating part 2, a 3D printing apparatus can be used, as shown symbolically in FIG. 2. In order to enhance the quality of the parts that are produced, the 3D printing process can also be carried out in a closed region under different atmospheric conditions, such as pressure, temperature, humidity, gas composition, than those of an ambient atmosphere. For example, the printing may also take place in a clean room atmosphere or in a vacuum.

The 3D printing apparatus 7 comprises at least one printer controller 8, for example, a correspondingly programmed signal processor or microprocessor as well as at least one electronic memory 9. In order to produce an object the printer controller 8 is configured to control a print head 10 by means of data stored in the electronic memory 9. The aforementioned 3D model of the basic element of the long-range optical apparatus 1, the accessory part, the operating part 2, the contact part or the other part of the long-range optical apparatus 1 that is to be printed is stored in electronic form in the electronic memory 9. Thus, the 3D printing apparatus is controlled by means of the 3D model, stored in electronic form, in order to print an object in accordance with this model. Even if, in principle, it is possible to produce all of the parts of the long-range optical apparatus 1 by 3D printing, it is, however, also possible that individual parts, for example, a basic element of the long-range optical apparatus, for example, a part of a housing, are fabricated and printed in the customary way. Of course, it is also possible to print individual parts individually and to assemble them in a separate step. However, there is also the option of printing a larger module consisting of a plurality of individual parts.

The model of the object to be printed may be created by determining a surface geometry of the long-range optical apparatus 1 or a part of the long-range optical apparatus 1 that is used as a reference or an accessory part that is used as a reference. The surface geometry may be determined, for example, by scanning, for example, contact-free scanning with a light beam, by means of a triangulation method, by means of a molding apparatus or a combination of the said methods. A description of the surface geometry, obtained by triangulation or scanning, and the surface condition may be carried out, for example, in STL.

If a recording of the surface of the object to be printed is carried out by molding, then the molding apparatus for molding the body part, the long-range optical apparatus, a part thereof, the accessory part, the operating part or parts may comprise an irreversibly deformable impression body. The impression body may be, for example, a molding foam, a gel cushion or a gypsum cushion, wherein the impression body is formed into a negative shape of the actual shape. The corresponding surface geometry of the object may be determined, for example, by scanning the impression body and/or triangulation.

However, the molding apparatus may also comprise a force sensitive impression body, in particular, an impression body with a force sensor, which converts a force, acting on the force sensor, into an electrical parameter, in particular, a piezoelectric and/or resistive and/or capacitive force sensor. As an alternative or in addition, the impression body may comprise an arrangement of touch elements. Such touch elements may be, for example, spring-biased touch probes, which project from the impression body in a quiescent position and adapt to the actual shape when the long-range optical device is being held or received. The actual shape can be determined directly by determining the indentation path. One variant may also consist of the feature that the molding apparatus is formed by means of a depth sensor or by means of a volume scanner and that the model is formed by determining discrete distance values between the molding apparatus and the corresponding part or element; and that a coordinate network is formed from the determined distance values by means of a vector transformation. A depth sensor may be formed, for example, by means of a stereo camera or TOF (time-of-flight) camera and generates an image of the recorded region, wherein each pixel of the recorded image is assigned to a distance information.

According to an additional embodiment, the impression body may also comprise a transparent, elastically deformable volumetric body, wherein triangulation points of the inner surface geometry of the impression body can be recorded by an optical scanning apparatus, arranged in the impression body interior. Furthermore, the force sensitive impression body may comprise a transparent, non-deformable volumetric body, wherein an impression image on the outer surface of the impression body is recorded by an optical imaging apparatus disposed inside the impression body.

In addition to the imaging apparatus, there is also preferably a lighting apparatus; and light is emitted in the direction of the outer surface of the impression body. Molding the element or part will produce regions, in which a deviation of the actual shape of the element or part from the generic shape of the impression body will result in the impression body having a higher degree of deformation. This deformation can be readily recorded by optical means owing to its characteristic brightness distribution and allows the force conditions prevailing on the outer surface of the impression to be determined by means of the brightness distribution, in particular, by using optical filtering methods. In order to make it easier for the user to personalize the long-range optical apparatus according to his conceptions, the user can access the electronic model over a user interface and can process the data or copies of said data. The user interface may be implemented in an App, which is installed in a mobile end device, for example, a cellphone, a tablet, a PDA, etc. As an alternative, the user interface may also be a part of a program that is installed in a workstation computer or a laptop.

After opening the user interface the user can select in a step i) a surface condition or the geometry of the part to be printed, for example, the color or a roughness. The selection of the geometric properties of the part to be printed may be carried out, for example, with the aid of a program by means of the stored standard models of various long range optical apparatuses. Thus, the user can enter, for example, a model number of a long-range optical apparatus and the information that he would like to print, for example, an eye cap. Given this information, it is possible to suggest one or more types of eye caps with matching geometry, from which the user can choose. In addition, it can be provided that the user can make even more changes in the designs suggested. In addition, there is also the possibility that a user can freely design without any restrictions the components that are then scaled to the correct size for a specific kind of long-range optical apparatus by means of a corresponding program.

In a step ii) the object to be printed is printed with the 3D printing method.

In order to be able to give the user an impression of how the selected design of the object to be printed will look before printing, the selected parameters can be used to output a preview of the appearance on a screen of an end device of the user.

How the object to be printed, for example, an armoring, will fit into a composite image of the long-range optical apparatus, can be shown to a user in advance, if a preview of the combination of the basic element and the part to be printed are outputted by means of the i) selected parameters and ii) a model of the basic element of the long range optical apparatus.

As can also be seen in FIG. 1, an armoring 11, in particular, a casing, for the housing 3 can be produced by means of the 3D printing method. The armoring 11 can be produced from two or more pieces and can be assembled in a releasable or non-releasable manner via the housing 3 to form one part. As an alternative, the armoring 11 can be produced as a covering part and can be pulled over the housing 3 at least in certain section. The armoring 11 can be connected to the housing 3 in a shape fitting and/or force fitting manner. In addition, the armoring 11 can also be printed directly on the housing 3. Furthermore, the armoring 11 can also be adapted to the anatomical conditions of a user. Thus, for example, the thickness of the armoring can be adapted to the size of a user's hand. The armoring can also be adapted in order to implement other desired functions, such as, for example, impact protection.

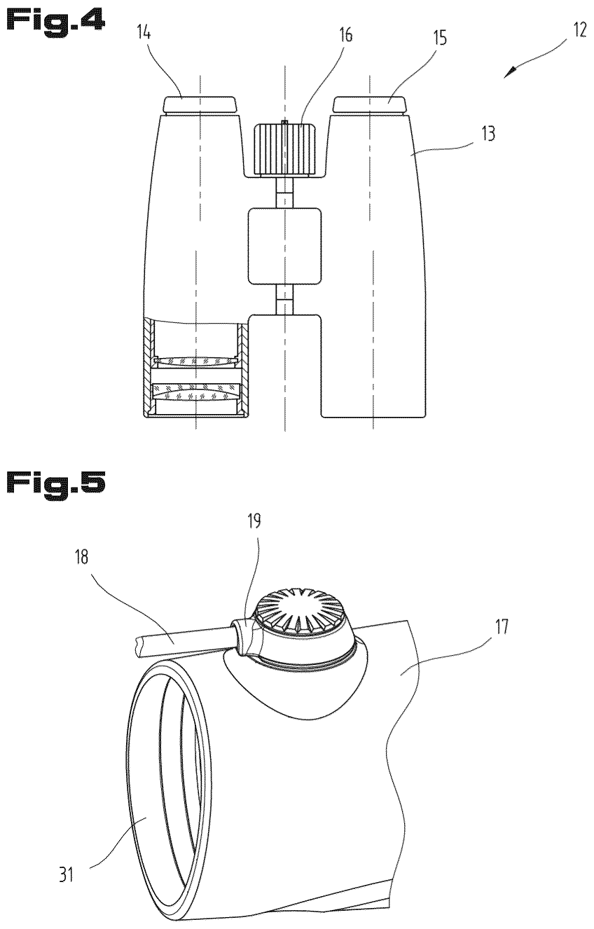

According to FIG. 4, another variant of the long-range optical apparatus 12 may be a binocular telescope. In this case, too, the aforesaid with respect to FIGS. 1 and 3 applies that all of the parts of the long-range optical apparatus can be produced by means of a 3D printing method. In particular, it is advantageous if the housing 13 or contact parts, which are anatomically adapted to the user, such as the eye caps 14, 15 or the holding sections of the housing 13, or an operating element 16 in the form of a rotating ring or a rotary knob for changing an optical adjustment are produced with the method of the present invention.

FIG. 5 shows a section of a housing 17 of a long-range optical apparatus, in which an accessory part in the form of a carrying strap 18 is attached to the housing 17. An add-on part 19 in the form of a rotary knob is used to attach the carrying strap 18. The carrying strap 18 and the add-on part 19 can also be produced with the method of the present invention.

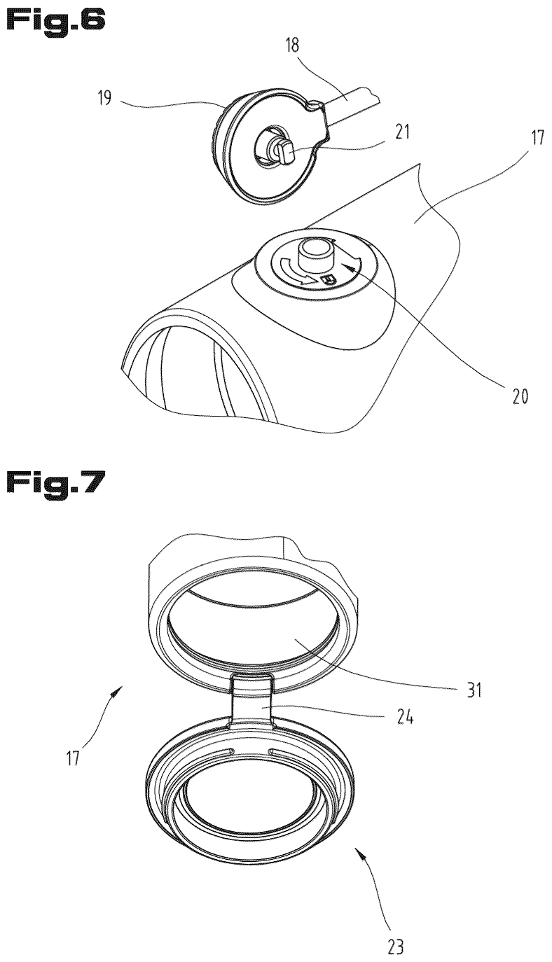

As can be seen in FIG. 6, a first interface element 20, which is designed for connecting to the add-on part 19, is disposed on the housing 17, wherein a second interface element 21, which can be connected to the first interface element, can be printed on the add-on part in accordance with the shape of the first interface element. At this point it should be pointed out that it is possible to print directly on the housing 17 or said housing can also be produced in its entirety by means of 3D printing.

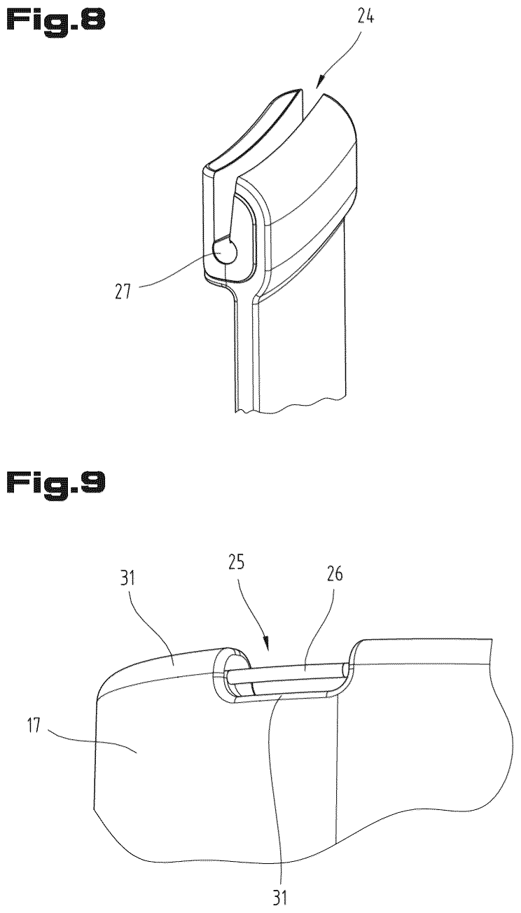

As can be seen in FIG. 7, the accessory part may also be an objective lens cover 23, which can be attached to the housing 17 by means of a connecting piece 24 on an interface element 25, which is located on the housing 17 (FIGS. 8 and 9). The interface element 25 can be designed as a bridge 26, which is integrated in the housing 17 or an armoring 31 thereof. The connecting piece 24 may have a receptacle 27 for the bridge 26. In this case the receptacle 27 also constitutes an interface element and forms a mechanical interface together with the bridge 26. As an alternative, the objective lens cover 23 can be formed in one piece with the bridge 26 and the connecting piece 24. In addition, the connecting piece 24 can be formed in one piece with the housing 17 or the armoring, for example, a casing of the housing 17, wherein the objective lens cover 23 can be formed as a separate component.

Both the housing 17 and/or an armoring or a casing of the housing 17 as well as the objective lens cover 23 and the bridge 26 and the connecting piece 24 can be produced by means of 3D printing.

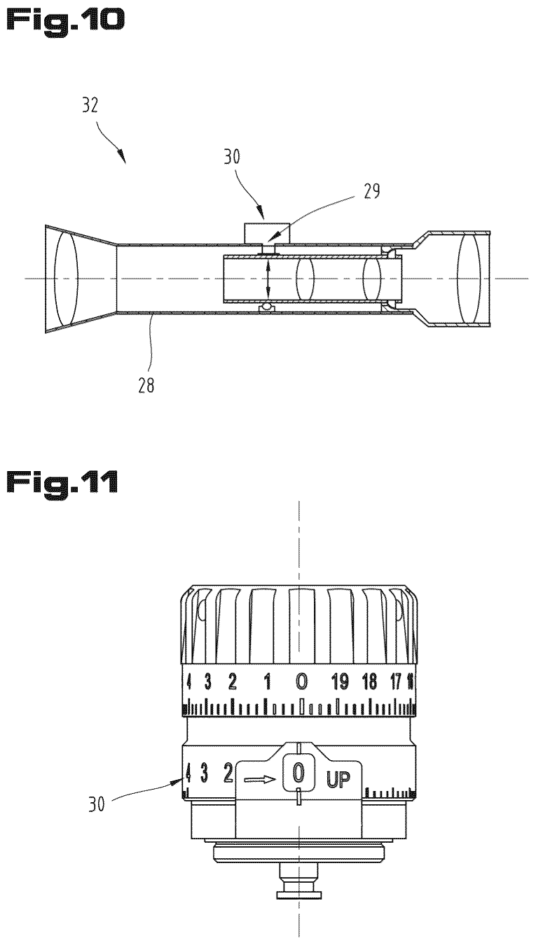

According to the variant of the invention shown in FIG. 10, the long-range optical apparatus 32, which is produced in accordance with the method of the present invention, may also be a rifle scope. As can be seen from FIG. 10, the housing 28 may comprise a mounting interface 29 for another component, for example, the operating part 30 (shown in FIG. 11), which is designed in the form of a ballistic turret. The mounting interface 29 can be printed, for example, on the housing 17. It may also be advantageous if an interface for mounting the rifle scope on a weapon is printed directly on the housing or with the housing, wherein the interface is specifically adapted to the weapon used or the application or to the customer's request.

All data with respect to the ranges of values in the description of the object of the invention are to be understood to include any and all subranges thereof. For example, the data 1 to 10 refer to the fact that all subranges, starting from the lower limit 1 and the upper limit 10, are included, i.e., all subranges beginning at a lower limit of 1 or greater and ending at an upper limit of 10 or less, for example, 1 to 1.7 or 3.2 to 8.1 or 5.5 to 10.

As a matter of form it should be pointed out in closing that for a better understanding of the construction, elements were shown partly unscaled and/or scaled up and/or scaled down.

1. A method for producing a long-range optical apparatus selected from a group consisting of a binocular, a monocular telescope, a spotting scope, a rifle scope, a night vision device, and a range finder,
wherein a part of the long-range optical apparatus is produced using a three-dimensional (3D) printing method,
wherein a model of the part that is to be printed is stored in electronic form and a 3D printing apparatus is controlled by means of the model stored in electronic form,
wherein the model of the part that is to be printed is created by determining a surface geometry of the part of the long-range optical apparatus that is used as a reference,
wherein the surface geometry is determined by means of a molding apparatus,
wherein the molding apparatus comprises an irreversibly deformable impression body, wherein the irreversibly deformable impression body is either a molding foam or a gel cushion or a gypsum cushion, wherein the impression body is deformed into a negative shape of a shape of the part of the long-range optical apparatus that is used as the reference.

2. The method, according to claim 1, wherein the model of the part that is to be printed is created as a computer-aided design (CAD) model and is stored.

3. The method, according to claim 1, wherein in a step i) at least one value of a surface parameter of the part of the long-range optical apparatus that is to be printed is selected; and in a step ii) the part of the long-range optical apparatus is printed with the 3D printing method.

4. The method, according to claim 3, whereby means of the surface parameters selected in step i) a preview of the appearance of the part of the long-range optical apparatus is outputted on a screen.

5. The method, according to claim 4, whereby means of the surface parameters selected in step i) and the at least one model of the part of the long-range optical apparatus that is to be produced is outputted.

6. The method, according to claim 3, wherein step i) the at least one value is selected over a graphics user interface.

7. The method, according to claim 1, wherein a housing of the long-range optical apparatus is produced at least in sections by means of the 3D printing method.

8. The method, according to claim 7, wherein an armoring, in particular, a casing, for the housing of the long-range optical apparatus is produced by means of the 3D printing method.

9. The method, according to claim 7, wherein an armoring is produced in at least two pieces and is assembled in a releasable and non-releasable manner via the housing to form one part.

10. The method, according to claim 8, wherein the armoring is produced as a covering part and is pulled over the housing at least in certain sections.

11. The method, according to claim 8, wherein the armoring is connected to the housing in a force fitting or shape fitting manner.

12. The method, according to claim 7, wherein at least one add-on part for the housing of the long-range optical apparatus is printed and connected to the housing.

13. The method, according to claim 12, wherein at least one first interface element, which is designed for connecting to the add-on part, is disposed on the housing, wherein at least one second interface element, which can be connected to the at least one first interface element, is printed in accordance with the shape of the at least one first interface element on the add-on part.

14. The method, according to claim 12, wherein at least one operating part is printed as an add-on part, wherein the operating part is designed for changing an optical adjustment of the long-range optical apparatus, in particular, for changing a diopter adjustment, a focus or a magnification of the long-range optical apparatus.

15. The method, according to claim 12, wherein the at least one operating part is printed as an add-on part in the form of a push button or a rotary knob or a switch or a ballistic turret or component of a ballistic turret.

16. The method, according to claim 1, wherein at least one anatomically shaped contact part or holding part, in particular, an eye cup or a grip or a grip shell, of the long-range optical apparatus is produced for a user, wherein in order to produce the contact part an actual anatomical shape of a body part of the user that comes into contact with the long-range optical apparatus is determined; and a contact section of the contact part that rests against the body part when the long-range optical apparatus is used is printed according to the actual anatomical shape.

17. The method, according to claim 16, wherein a surface geometry of the body part is determined, in order to ascertain the actual anatomical shape.

18. The method, according to claim 17, wherein the surface geometry of the body part is determined by scanning, in particular, by contact-free scanning or by means of a triangulation method or by means of a molding apparatus.

19. The method, according to claim 1, wherein the surface geometry of the part of the long-range optical apparatus that is to be printed is determined by scanning the impression body.

20. The method, according to claim 1, wherein the surface geometry is determined by scanning the impression body in a contact-free manner, in particular, by means of a light slit method.

21. The method, according to claim 1, wherein the molding apparatus comprises a force sensitive impression body, in particular, an impression body with a force sensor, which converts the force, acting on the force sensor, into an electrical parameter, in particular, a piezoelectric or resistive or capacitive force sensor.

22. The method, according to claim 1, wherein the molding apparatus comprises an arrangement of touch elements.

23. The method, according to claim 1, wherein the impression body comprises a transparent, elastically deformable volumetric body, wherein triangulation points of the inner surface geometry of the impression body are recorded by an optical scanning apparatus, arranged in the impression body interior.

24. The method, according to claim 1, wherein the force sensitive impression body comprises a transparent, non-deformable volumetric body, wherein an impression image of the outer surface of the impression body is recorded by an optical imaging apparatus disposed in the impression body interior.

25. The method, according to claim 7, wherein the housing is printed on directly by means of the 3D printing method.

26. The method, according to claim 7, wherein a mounting interface for a further component is printed at or on the housing.

27. The method, according to claim 1, wherein the 3D printing method is a free space method or a powder bed method.

28. The method, according to any claim 1, wherein the 3D printing method is a free space method with a volume variable material.

29. The method, according to claim 1, wherein the at least one 3D printing method comprises a laser beam melting method or an electronic beam melting method or a stereolithography method or a digital light processing method or a polyjet modeling method or fused deposition modeling method or a multi-jet modeling method or a binder jetting method or a laser deposition welding method or a cold gas spraying method.

30. The method, according to claim 1, wherein the whole long-range optical apparatus is produced by the at least one 3D printing method.

31. The method, according to claim 1, wherein the 3D printing method is carried out in a closed region under different atmospheric conditions, such as pressure, temperature, humidity, gas composition, than those of an ambient atmosphere.
